(19) United States
(12) Patent Application Publication
(10) Pub. No.: US 2021/0233264 A1
(43) Pub. Date: Jul. 29, 2021

(54) CORK CODING METHOD AND DEVICE, CORK TRACING METHOD AND DEVICE, AND AN ELECTRONIC DEVICE

(71) Applicants: HEBEI BELIN CORK CO., LTD., Shijiazhuang City (CN); MICROVIEW SCIENCE AND TECHNOLOGY CO., LTD., Beijing (CN)

(72) Inventors: Jun OUYANG, Beijing (CN); Xinyi ZHAO, Shijiazhuang City (CN); Xiaoming XIE, Beijing (CN); Xu ZHANG, Beijing (CN); Chun LU, Beijing (CN); Lin WANG, Beijing (CN); Kai TAN, Beijing (CN); Xingang ZHAO, Shijiazhuang City (CN)

(21) Appl. No.: 15/734,698

(22) PCT Filed: May 8, 2019
(86) PCT No.: PCT/CN2019/086034

§ 371 Date: Dec. 3, 2020

(51) Int. Cl. G06T 7/40; G06K 9/32; G06K 9/46; B65D 39/00

(52) U.S. Cl. CPC G06T 7/40; G06K 9/3233; G06K 9/4609; G06T 2207/30128; G06K 2209/01; G06K 2209/21; B65D 39/0058

(57) ABSTRACT

The present application discloses a cork coding method and device, a cork tracing method and device, and an electronic device, wherein, the cork coding method comprises: acquiring an original image of a to-be-coded cork with an original character code; identifying the original character code in the original image; determining whether the original character code is matched with a character already inputted into a database; extracting an original texture feature of an to-be-coded cork from the original image, if the original character code is not matched with the character in the database; and establishing a one-to-one correspondence between the original texture feature and the original character code. In the method the original character code on the cork corresponds to the original texture feature on the cork, to guarantee the uniqueness of the original character code and the original texture feature

### TECHNICAL FIELD

The present application relates to the technical field of red wine, specifically related to a cork coding method and device, a cork tracing method and device, and an electronic device.

### BACKGROUND

In the red wine production and sales market, which is very large, it is necessary to trace the products and logistics to ensure that the product is authentic and guarantee the rights of consumers. In the prior art, the only traceable identity verification is usually realized via unique verification of the red wine itself and the wine bottle. However, the red wine and wine bottles are easy to be imitated, rendering the verification uncontrollable.

### SUMMARY

To this end, embodiments of the present application provide a cork coding method and device, a cork tracing method and device, an electronic device and readable storage medium, so as to solve the problem that in the prior art the red wine and wine bottles are easy to be imitated, rendering the verification uncontrollable.

An embodiment of the present application provides a cork coding method, comprising: acquiring an original image of a to-be-coded cork with an original character code; identifying the original character code in the original image; determining whether the original character code is matched with a character already inputted into a database; extracting an original texture feature of an to-be-coded cork from the original image, if the original character code is not matched with the character in the database; and establishing a one-to-one correspondence between the original texture feature and the original character code.

An embodiment of the present application provides a cork tracing method, comprising: acquiring a current image of the to-be-traced cork, wherein the to-be-traced cork is coded with the cork coding method in the first aspect of the present application; obtaining a current texture feature of the to-be-traced cork according to the current image; comparing the current texture feature with the original texture feature pre-stored in the database, and generating a comparison result; and transmitting the comparison result.

Optionally, the step of comparing the current texture feature with the original texture feature pre-stored in the database and generating a comparison result comprises determining whether the current texture feature is matched with the original texture feature pre-stored in the database; and generating tracing information when the current texture feature is matched with the original texture feature.

Optionally, before the step of determining whether the current texture feature is matched with the original texture feature pre-stored in the database, the cork tracing method further comprises acquiring the original texture feature pre-stored in the database.

Optionally, the step of acquiring the original texture feature pre-stored in the database comprises acquiring a current character code in the current image; determining whether the current character code is matched with the original character code pre-stored in the database; and looking up for the original texture feature corresponding to the original character code in the database according to the original character code, if the current character code is matched with the original character code.

### BRIEF DESCRIPTION OF THE DRAWINGS

In order to make a clearer description of technical solutions in specific implementations of the present application or the prior art, drawings involved in description for the specific implementations or the prior art will be briefly introduced, and apparently, the drawings described below illustrate some implementations of the present application, for one with ordinary skill in the art, other drawings can also be obtained in accordance with these drawings without delivering creative efforts.

FIG. 1 is a flow chart of an embodiment of a cork coding method;

FIG. 2 is another flow chart of an embodiment of the cork coding method;

FIG. 3 is a further flow chart of an embodiment of the cork coding method;

FIG. 4 is a further flow chart of an embodiment of the cork coding method;

FIG. 5 is a further flow chart of an embodiment of the cork coding method;

FIG. 6 is a flow chart of an embodiment of a cork tracing method;

FIG. 7 is another flow chart of an embodiment of a cork tracing method;

FIG. 8 is another flow chart of an embodiment of a cork tracing method;

FIG. 9 is another flow chart of an embodiment of a cork tracing method;

FIG. 10 is a block diagram of an embodiment of a cork encoding device;

FIG. 11 is a block diagram of an embodiment of a cork tracing device;

FIG. 12 is a schematic diagram of the hardware structure of an electronic device of an embodiment of the present application.

### DETAILED DESCRIPTION

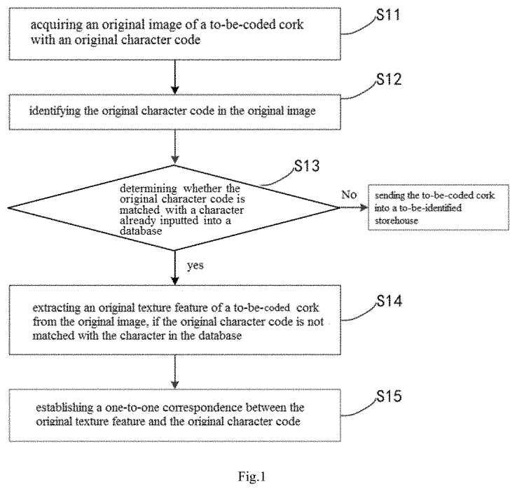

An embodiment of the present application provides a cork coding method, as shown in FIGS. 1, comprising steps S11-S15.

Step S11: acquiring an original image of a to-be-coded cork with an original character code.

In an embodiment, a to-be-coded cork is moved to a test working station, and photographed by a line-scan camera, the number of lines collected by the camera, which is pre-set, is determined according to the step accuracy of a pulse encoder, so as to collect the side image of the cork, which can be used as the original image. Of course, the original image can also be collected in other ways, for example, from videos.

In an embodiment, the original character code can be a character string composed of letters, numbers, special characters, etc., or it can be a bar code, etc., which indicates information such as the time and location of coding.

Step S12: identifying the original character code in the original image. Specifically, OCR is performed to the original image to identify the original character code, which can be set in advance through a number protocol according to the user's needs.

Step S13: determining whether the original character code is matched with a character already inputted into a database. When it is not matched, performing step S14; when it is matched, it means that the character is already present in the database, the cork is sent into a to-be-identified storehouse, so that it can be filtered again later or discarded when the above character code already exists in the database.

Step S14: extracting an original texture feature of a to-be-coded cork from the original image, if the original character code is not matched with the character in the database.

Specifically, the degree of matching between the two can be determined by a matching score, for example, when the matching score is less than 80%, it is determined that the two are not matched. This embodiment is only illustrative and not limited to this.

Since the wine bottle cork is made of natural oak, with a great deal of texture feature information on the surface thereof, and this information is unique, so as to realize unique identity authentication through the texture feature, and management and control of the products, thereby realizing source tracing of the red wine.

When the two do not match, the original character code is guaranteed to be unique, and then analysis is performed by a BLOB algorithm to obtain the original texture feature of the cork. The texture feature may include the shape, color, number of holes or gaps, size, and relative position relationship of the textures, etc.

Step S15: establishing a one-to-one correspondence between the original texture feature and the original character code, to facilitate looking up of a corresponding original texture feature according to the original character code in the subsequent process, so as to trace the red wine and verify the authenticity thereof.

This method makes the original character code on the cork correspond to the original texture feature of the cork to ensure the uniqueness of the original character code and the original texture feature, so that the source of red wine can be traced through the texture feature subsequently.

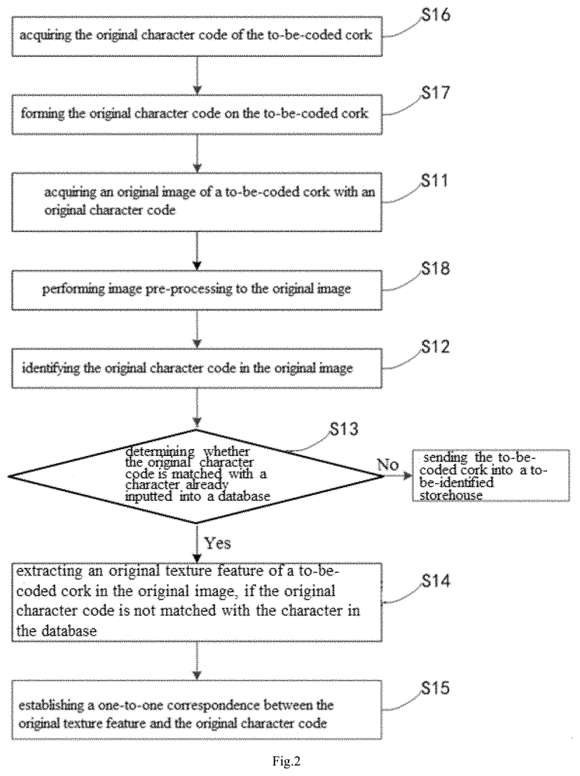

In an embodiment, as shown in FIG. 2, the method further comprises steps S16-S19.

Before step S11, the method further comprises steps S16 and S17.

Step S16: acquiring the original character code of the to-be-coded cork.

Specifically, the original character code, as the only code, requires a unified character coding format, which can be set through a pre-set number protocol, so as to serve as a format specification for photographing an original image in the subsequent process, and identifying the codes.

Step S17: forming the original character code on the to-be-coded cork.

Specifically, the original character code is engraved on the cork by a laser printer connected to a vibrating table. Each cork reaches the position of the laser coding, and laser coding is performed according to the preset pattern and number (the only one in the world). The laser coding can be carried out at a position on the side of the cork, specifically, 15-20 degrees on the side of the cork, or the area occupied by the laser coding is less than 10% of the total area of the side.

Before step S12, the method further comprises step S18, i.e., performing image pre-processing to the original image, specifically, brightness correction and trimming of the image, facilitating subsequent accurate identification of the original character code and improving the accuracy of the identification.

After step S15, the method further comprises step S19: storing the correspondence between the texture feature and the character code in the database, and updating the stored information in the database for subsequent querying and tracing.

The method further comprises: sending the to-be-coded cork into a to-be-identified storehouse, if the original character code in the original image is not identified, so that the above-mentioned character code can be re-filtered later or discarded when already existing in the database.

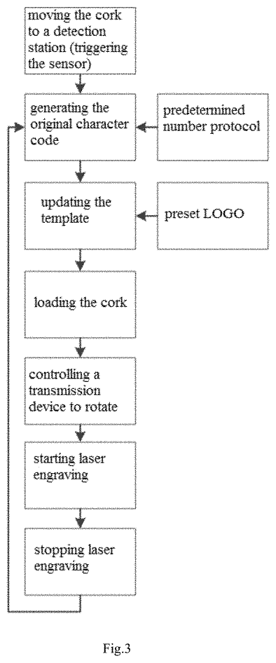

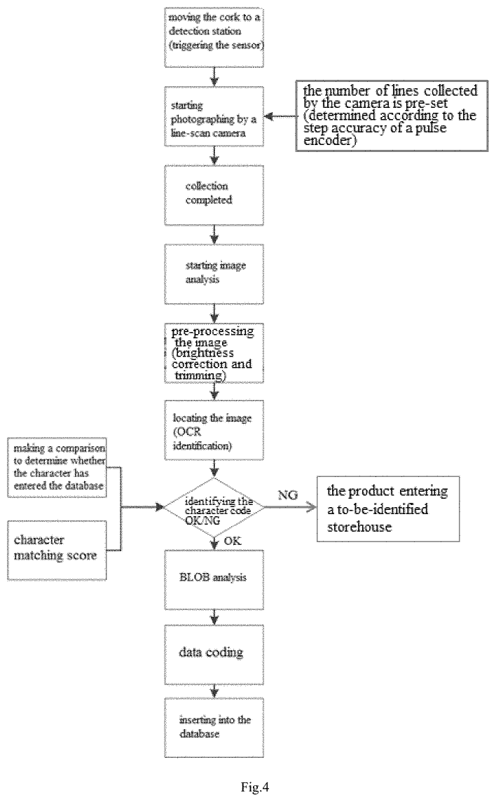

FIG. 3 and FIG. 4 are respectively another flow chart of the cork coding method. Firstly, the to-be-coded cork is moved to a detection station, the sensor is triggered to determine that the cork has reached a designated position to start the subsequent process, then the original character code is generated according to a predetermined number protocol, and the character code, which is unique in the world, is further formed into a new template together with the wine's trademark, name and other pre-set LOGO. After the cork is loaded, a transmission device is controlled to drive the cork to rotate, and the laser coding machine performs engraving according to the updated template, by forming the original character code on the cork. Then, an industrial camera is connected to take pictures. When the cork reaches the detection station, the sensor is triggered to control the camera to start collecting images, after which the images are pre-processed and positioned. Then OCR is performed to identify the original character code in the original image, for example, by making a comparison to determine a matching score of the character, and then making a comparison to determine whether the character has been inputted into the database. If the identified character code has not been inputted the database, BLOB analysis is performed on the original image to obtain the original texture feature, and finally one-to-one correspondence is established between the original character code and the original texture feature, so as to realize data encoding, after which the encoded data are stored in the database.

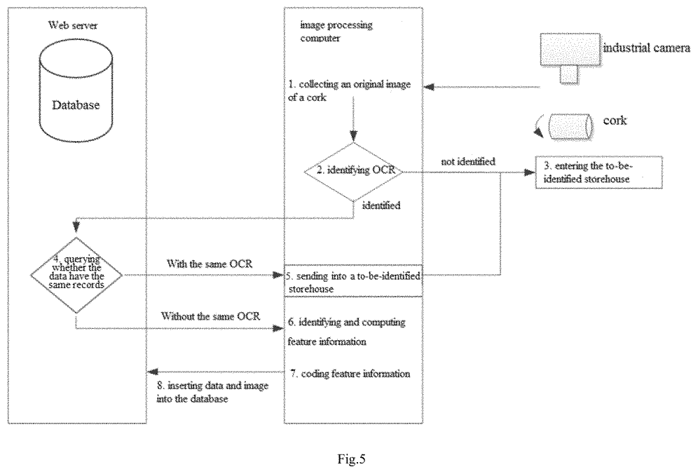

The communication process between an acquisition computer and the database is shown in FIG. 5, which is a photograph of an industrial image, wherein the unique feature of the cork is analysed, coded and recorded in a traceable database.

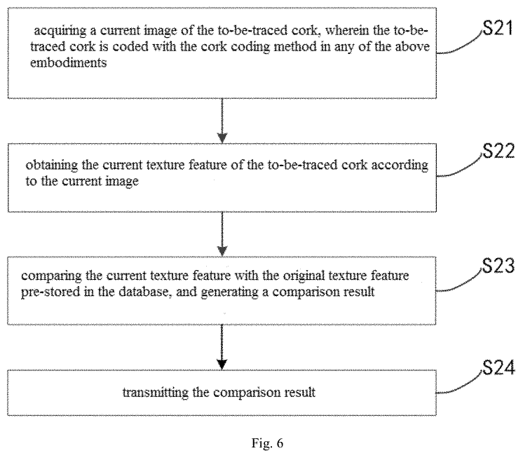

This embodiment also provides a cork tracing method, as shown in FIG. 6, including steps S21-S24.

Step S21: acquiring a current image of the to-be-traced cork, wherein the to-be-traced cork is coded with the cork coding method in any of the above embodiments.

Specifically, the to-be-traced cork can be photographed through a mobile terminal (such as a mobile phone, etc.), or other image collection devices, such as industrial cameras, code scanners, etc., to collect the current image. For example, Apps installed on a mobile phone is able to take pictures of the cork, and in order to prevent undesired shooting, a frame for shooting the character is set, for locating the character area of the cork, and the picture data can be compressed (or trimmed according to the size of the positioning frame) before uploading.
step S22: obtaining the current texture feature of the to-be-traced cork according to the current image.

Specifically, performing image processing to the current image to identify the current texture feature of the cork.

Step S23: comparing the current texture feature with the original texture feature pre-stored in the database, and generating a comparison result, wherein the current texture feature and the original texture feature in the database are compared to determine whether they are consistent, so as to generate the comparison result.

If the two match, the comparison result indicates the cork passes the verification process while displaying the corresponding tracing information (such as the name and type of the wine, etc.). If the two do not match, the verification fails, indicating no result is found. After that, the character can be manually inputted, to realize the data query function; or the original image of the server can be downloaded to realize manual comparison.

Step S24: transmitting the comparison result. Specifically, the comparison result is sent to a mobile terminal to be viewed by a user, so that the only traceable identity verification for the wine can be achieved according to the comparison result.

The method achieves the verification and tracing of a unique cork by comparing the current texture feature with the original texture feature.

In an embodiment, as shown in FIG. 7, step S23 comprises steps S231-S233.

Step S231: acquiring an original texture feature pre-stored in a database.

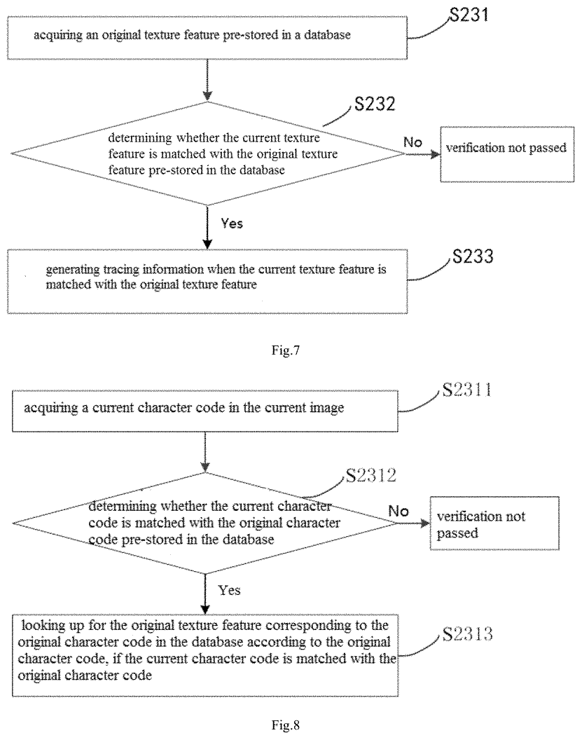

Specifically, as shown in FIG. 8, step S231 may comprise steps S2311-S2313.

Step S2311: acquiring a current character code in the current image. Specifically, the current character code in the current image may be identified via OCR.

Step S2312: determining whether the current character code is matched with the original character code pre-stored in the database. Specifically, the matching score of the two can be used to determine whether they are matched. For example, the match is considered successful if the matching score is greater than 90%.

Step S2313: looking up for the original texture feature corresponding to the original character code in the database according to the original character code, if the current character code is matched with the original character code. The case that the two match indicates that the character code is stored in the database, and the original texture feature is looked up through the correspondence between the original character code and the original texture feature.

Step S232: determining whether the current texture feature is matched with the original texture feature pre-stored in the database. Specifically the similarity between the two can be used to determine whether the current texture feature is matched with the original texture feature. For example, a similarity greater than 95% indicates the two are matched.

Step S233: generating tracing information when the current texture feature is matched with the original texture feature.

In an embodiment, the case that the two are matched indicates the cork has a reliable source, and the generated tracing information can include the name, type and date of manufacture of the wine, and logistics information as well.

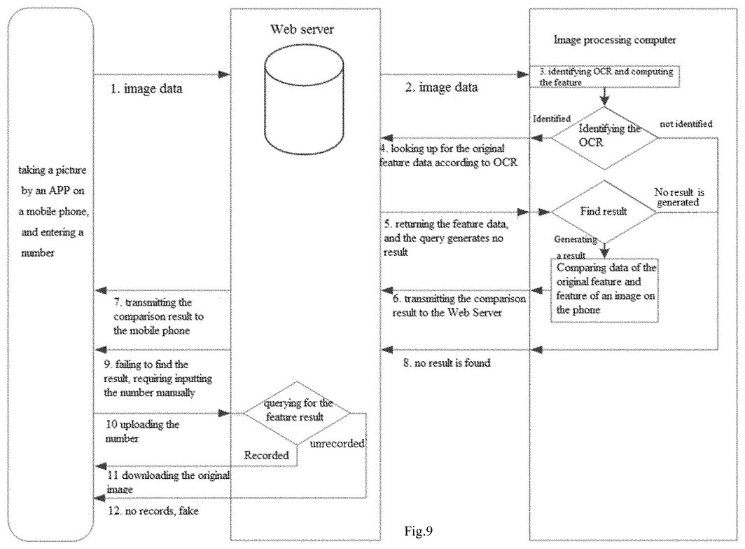

FIG. 9 is another flow chart of the cork tracing method. Apps installed on a mobile phone is able to take pictures of the cork, and in order to prevent undesired shooting, a frame for shooting the character is set, for locating the character area of the cork, and the picture data can be compressed (or trimmed according to the size of the positioning frame) before uploading. The character can be manually entered to realize a data query function; and the original picture of the server can be downloaded to realize manual comparison.

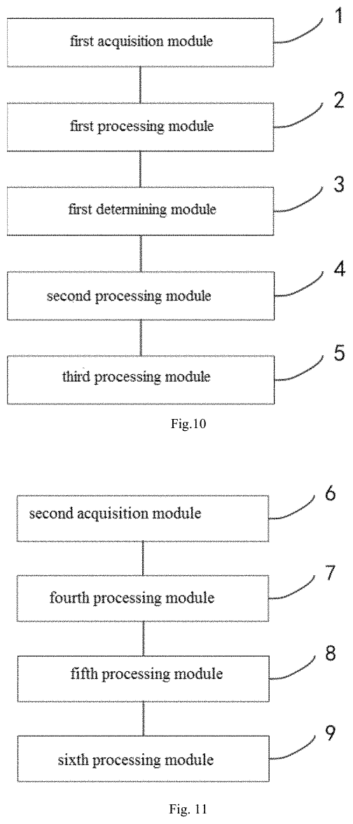

An embodiment of the present application provides a cork coding device, as shown in FIG. 10, including: a first acquisition module 1, for acquiring an original image of a to-be-coded cork with an original character code, referring to step S11; a first processing module 2, for identifying the original image in the original character code, referring to step S12; a first determining module 3, for determining whether the original character code is matched with a character already inputted into a database, referring to step S13; a second processing module 4, for extracting an original texture feature of an to-be-coded cork from the original image, if the original character code is not matched with the character in the database, referring to step S14; a third processing module 5, for establishing a one-to-one correspondence between the original texture feature and the original character code, referring to step S15.

The device further comprises: a seventh processing module, for acquiring the original character code of the to-be-coded cork; an eighth processing module, for forming the original character code on the to-be-coded cork; a ninth processing module, for performing image pre-processing to the original image; a tenth processing module, for storing the correspondence between the texture feature and the character code in a database.

The device further comprises: an eleventh processing module, for sending the to-be-coded cork into a to-be-identified storehouse under control, if the original character code in the original image is not identified, or the original character code is matched with the character in the database.

An embodiment of the present application provides a cork tracing device, as shown in FIG. 11, comprising: a second acquisition module 6, for acquiring a current image of a to-be-traced cork, wherein the to-be-traced cork is coded with the cork coding method in any of the embodiments, referring to step S21; a fourth processing module 7, for obtaining a current texture feature of the to-be-traced cork according to the current image, referring to step S22; a fifth processing module 8, for comparing the current texture feature with the original texture feature pre-stored in the database, and generating a comparison result, referring to step S23; and a sixth processing module 9, for transmitting the comparison result, referring to step S24.

The fifth processing module comprises: a first determining sub-module, for determining whether the current texture feature is matched with the original texture feature pre-stored in the database; and a first processing sub-module, for generating tracing information when the current texture feature is matched with the original texture feature;
a fifth processing module, further comprising: a second processing sub-module, for acquiring the original texture feature pre-stored in the database.

The second processing sub-module comprises: a first acquisition module, for acquiring the current character code in the current image; a first determining unit, for determining whether the current character code is matched with the original character code pre-stored in the database; a first processing unit, looking up for the original texture feature corresponding to the original character code in the database according to the original character code, if the current character code is matched with the original character code.

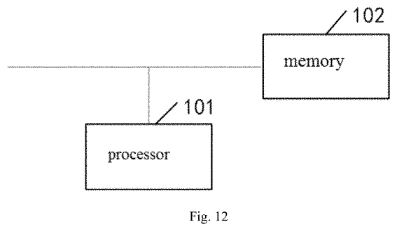

An embodiment of the present application further provides an electronic device, as shown in FIG. 12, comprising: a processor 101 and memory 102, which are in communication connection, wherein the memory stores computer instructions, which are executed by the processor, to implement the cork coding method in any of the embodiments of the present application as stated above, or to implement the cork tracing method in any of the embodiments of the present application as stated above, wherein, the processor 101 and the memory 102 can be connected by a bus or other means. In FIG. 12, the bus connection is taken as an example.

An embodiment of the present application further provides a computer readable storage medium, which stores computer instructions thereon, for allowing a computer to implement the cork coding method in any of the above embodiments, or to implement the cork tracing method in any of the above embodiments. Those skilled in the art can understand that the realization of all or part of the processes in the above-mentioned embodiments of the methods can be completed by instructing the relevant hardware through a computer program which can be stored in a computer readable storage medium. When the program is executed, it can include the processes in the above embodiments of the methods. Among them, the storage medium can be a magnetic disk, an optical disc, a read-only memory, a random storage memory, a flash memory, a hard disk or a solid state drive, etc., or a combination thereof.

1. A cork coding method, comprising:
acquiring an original image of a to-be-coded cork with an original character code;
identifying the original character code in the original image;
determining whether the original character code is matched with a character already inputted into a database;
extracting an original texture feature of a to-be-coded cork from the original image, if the original character code is not matched with the character in the database; and
establishing a one-to-one correspondence between the original texture feature and the original character code.

2. The method of claim 1, before the step of acquiring an original image of a to-be-coded cork with an original character code, further comprising:
acquiring the original character code of the to-be-coded cork; and
forming the original character code on the to-be-coded cork.

3. The method of claim 1, after the step of establishing a one-to-one correspondence between the original texture feature and the original character code, further comprising:
storing the correspondence between the original texture feature and the original character code in a database.

4. The method of claim 1, before the step of identifying the original character code in the original image, further comprising:
performing image pre-processing to the original image.

5. The method of claim 1, further comprising: sending the to-be-coded cork into a to-be-identified storehouse, if the original character code in the original image is not identified, or when the original character code is being matched with the character in the database.

6. The method of claim 1, further comprising:
acquiring a current image of a to-be-traced cork, wherein the to-be-traced cork is the to-be-coded cork coded by the method of claim 1;
obtaining a current texture feature of the to-be-traced cork according to the current image;
comparing the current texture feature with the original texture feature pre-stored in the database, and generating a comparison result; and
transmitting the comparison result.

7. The method of claim 6, wherein, the step of comparing the current texture feature with the original texture feature pre-stored in the database and generating a comparison result comprises:
determining whether the current texture feature is matched with the original texture feature pre-stored in the database; and
generating tracing information when the current texture feature is matched with the original texture feature.

8. The method of claim 7, before the step of determining whether the current texture feature is matched with the original texture feature pre-stored in the database, further comprising:
acquiring the original texture feature pre-stored in the database.

9. The method of claim 8, wherein, the step of acquiring the original texture feature pre-stored in the database comprises:
acquiring a current character code in the current image;
determining whether the current character code is matched with the original character code pre-stored in the database; and
looking up for the original texture feature corresponding to the original character code in the database according to the original character code, if the current character code is matched with the original character code.

10. A cork coding device, comprising:
a first acquisition module, for acquiring an original image of a to-be-coded cork with an original character code;
a first processing module, for identifying the original character code in the original image;
a first determining module, for determining whether the original character code is matched with a character already inputted into a database;
a second processing module, for extracting an original texture feature of a to-be-coded cork from the original image, if the original character code is not matched with the character in the database; and
a third processing module, for establishing a one-to-one correspondence between the original texture feature and the original character code.

11. A cork tracing device, comprising:
a second acquisition module, for acquiring a current image of a to-be-traced cork, wherein the to-be-traced cork is coded with a cork coding method comprising:
acquiring an original image of a to-be-coded cork with an original character code;
identifying the original character code in the original image;
determining whether the original character code is matched with a character already inputted into a database;
extracting an original texture feature of a to-be-coded cork from the original image, if the original character code is not matched with the character in the database; and
establishing a one-to-one correspondence between the original texture feature and the original character code;
a fourth processing module, for obtaining a current texture feature of the to-be-traced cork according to the current image;
a fifth processing module, for comparing the current texture feature with the original texture feature pre-stored in the database, and generating a comparison result; and
a sixth processing module, for transmitting the comparison result.

12. The method of claim 1, the method being executed by an electronic device, comprising:
memory and a processor, which are in communication connection, wherein the memory stores computer instructions, which are executed by the processor, to implement the cork coding method.

13. The method of claim 1, the method being implemented on computer comprising a computer readable storage medium, wherein, the computer readable storage medium stores computer instructions, for allowing a computer to implement the cork coding method.

14. The method of claim 6, the method being executed by an electronic device, comprising:
memory and a processor, which are in communication connection, wherein the memory stores computer instructions, which are executed by the processor.

15. The method of claim 6, the method being implemented on computer comprising a computer readable storage medium, wherein, the computer readable storage medium stores computer instructions, for allowing a computer to implement the cork coding method.

16. The method of claim 2, before the step of identifying the original character code in the original image, further comprising:
performing image pre-processing to the original image.

17. The method of claim 3, before the step of identifying the original character code in the original image, further comprising:
performing image pre-processing to the original image.

18. The method of claim 2, further comprising: sending the to-be-coded cork into a to-be-identified storehouse, if the original character code in the original image is not identified, or when the original character code is being matched with the character in the database.

19. The method of claim 3, further comprising: sending the to-be-coded cork into a to-be-identified storehouse, if the original character code in the original image is not identified, or when the original character code is being matched with the character in the database.

20. The method of claim 2, further comprising:
acquiring a current image of the to-be-coded cork;
obtaining a current texture feature of the to-be-traced cork according to the current image;
comparing the current texture feature with the original texture feature pre-stored in the database, and generating a comparison result; and
transmitting the comparison result.
